(19) United States
(12) Patent Application Publication
(10) Pub. No.: US 2023/0306689 A1
(43) Pub. Date: Sep. 28, 2023

(54) ALIGNING METAVERSE ACTIVITIES WITH MULTIPLE PHYSICAL ENVIRONMENTS

(71) Applicant: AT&T Intellectual Property I, L.P., Atlanta, GA (US)

(72) Inventors: Eric Zavesky, Austin, TX (US); James Pratt, Round Rock, TX (US); James Jackson, Austin, TX (US)

(21) Appl. No.: 17/656,540

(22) Filed: Mar. 25, 2022

(51) Int. Cl. G06T 19/00; G06T 7/70

(52) U.S. Cl. CPC G06T 19/006; G06T 7/70

(57) ABSTRACT

In one example, a method performed by a processing system including at least one processor includes acquiring information about a first physical environment of a first user of an extended reality environment, acquiring information about a second physical environment of a second user of the extended reality environment, rendering the extended reality environment in a manner that is compatible with both the first physical environment and the second physical environment, based on the information about the first physical environment and the information about the second physical environment, and applying a first adjustment to a presentation of the XR environment that is displayed to the first user, based on the information about the first physical environment, without making the first adjustment to a presentation of the XR environment that is displayed to the second user.

The present disclosure relates generally to extended reality (XR) systems, and relates more particularly to devices, non-transitory computer-readable media, and methods for aligning activities occurring in a metaverse with multiple physical environments.

### BACKGROUND

Extended reality (XR) is an umbrella term that has been used to refer to various different forms of immersive technologies, including virtual reality (VR), augmented reality (AR), mixed reality (MR), cinematic reality (CR), and diminished reality (DR). Generally speaking, XR technologies allow virtual world (e.g., digital) objects from the metaverse to be brought into “real” (e.g., non-virtual) world environments and real world objects to be brought into virtual environments, e.g., via overlays or other mechanisms. Within this context, the term “metaverse” is typically used to describe the convergence of a virtually enhanced physical reality and a persistent virtual space, e.g., a physically persistent virtual space with persistent, shared, three-dimensional virtual spaces linked into a perceived virtual universe. XR technologies may have applications in fields including architecture, sports training, medicine, real estate, gaming, television and film, engineering, travel, and others. As such, immersive experiences that rely on XR technologies are growing in popularity.

### SUMMARY

In one example, the present disclosure describes a device, computer-readable medium, and method for aligning activities occurring in a metaverse with multiple physical environments. For instance, in one example, a method performed by a processing system including at least one processor includes acquiring information about a first physical environment of a first user of an extended reality environment, acquiring information about a second physical environment of a second user of the extended reality environment, rendering the extended reality environment in a manner that is compatible with both the first physical environment and the second physical environment, based on the information about the first physical environment and the information about the second physical environment, and applying a first adjustment to a presentation of the XR environment that is displayed to the first user, based on the information about the first physical environment, without making the first adjustment to a presentation of the XR environment that is displayed to the second user.

In another example, a non-transitory computer-readable medium stores instructions which, when executed by a processing system, including at least one processor, cause the processing system to perform operations. The operations include acquiring information about a first physical environment of a first user of an extended reality environment, acquiring information about a second physical environment of a second user of the extended reality environment, rendering the extended reality environment in a manner that is compatible with both the first physical environment and the second physical environment, based on the information about the first physical environment and the information about the second physical environment, and applying a first adjustment to a presentation of the XR environment that is displayed to the first user, based on the information about the first physical environment, without making the first adjustment to a presentation of the XR environment that is displayed to the second user.

In another example, a device includes a processing system including at least one processor and a computer-readable medium storing instructions which, when executed by the processing system, cause the processing system to perform operations. The operations include acquiring information about a first physical environment of a first user of an extended reality environment, acquiring information about a second physical environment of a second user of the extended reality environment, rendering the extended reality environment in a manner that is compatible with both the first physical environment and the second physical environment, based on the information about the first physical environment and the information about the second physical environment, and applying a first adjustment to a presentation of the XR environment that is displayed to the first user, based on the information about the first physical environment, without making the first adjustment to a presentation of the XR environment that is displayed to the second user.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for aligning metaverse activities with multiple physical environments in accordance with the present disclosure;

FIG. 3 illustrates an example physical environment in which two curved paths that a user may walk in the physical environment are depicted; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enhances user engagement with extended reality (XR) environments by aligning metaverse activities with multiple physical environments. As discussed above, XR technologies allow virtual world (e.g., digital) objects from the metaverse to be brought into “real” (e.g., non-virtual) world environments and real world objects to be brought into virtual environments, e.g., via overlays or other mechanisms. This creates a more engaging and immersive experience for users and also allows users who may be physically located in different locations to engage with each other in a shared XR experience.

In many cases, a user may engage with an XR environment by utilizing a head mounted display, such as a VR headset, a pair of smart glasses or goggles, or the like. The head mounted display often blocks most or all of the user's view of their actual physical environment. However, many head mounted displays and associated XR systems have controls in place to identify the boundaries of the XR environment, so that the user does not collide with any objects in the physical environment that may be obscured by the head mounted display. For instance, the appearance of the XR environment (e.g., the location of a virtual item) may be adjusted to prevent the user from moving in a direction in which the user would be likely to collide with a wall, a piece of furniture, or another item that is present in the user's physical environment. Interactions of the user with certain virtual items in the XR environment may also be limited to prevent movements that might result in physical injury to the user.

Such systems work well to protect a single user joining an XR environment from a single physical location; however, many XR environments are designed to allow multiple users to join from multiple different physical locations and to experience the XR environment together (e.g., as a “shared immersion”). For instance, a user residing in New York may want to play an XR game with friends who reside in California and Texas. In this case, adjusting the XR environment to account for obstacles in the physical environments of all three users may result in a limited experience that is much less immersive than desired, thereby defeating the purpose of the XR experience.

Examples of the present disclosure provide a system that can merge the constraints of two or more different physical environments when rendering an XR environment that is shared by users who are physically located in the different physical environments. In addition, presentation of the XR environment to different users may be adjusted in different ways to accommodate for the constraints of the different users physical environments. For instance, the appearance of the XR environment, the locations of interactive virtual objects in the XR environment, the physics of interactions within the XR environment, and other aspects of the XR environment may be manipulated in a manner that allows all of the users to simultaneously have a safe and relatively consistent experience in the XR environment. Examples of the present disclosure may accommodate any number of users who may be joining an XR environment from any number of different physical environments (e.g., the users' respective homes or workplaces, commercial establishments, public spaces, and/or the like).

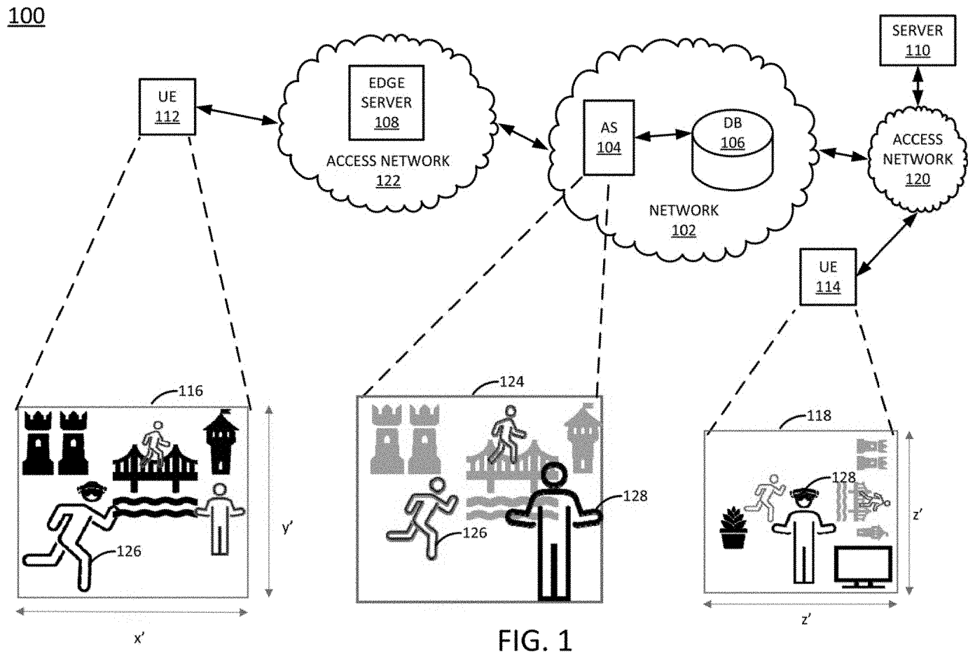

Within the context of the present disclosure, content created in “the metaverse” refers to items that are virtual in nature but have a persistent reference to a point (and possibly time) in space that corresponds to a physical instance. In the metaverse, an item (e.g., a rock, a castle, or a likeness of a living being) can exist at only one point (e.g., Oct. 25, 2013 at the steps of the state capitol in Austin, Texas) or across all points (e.g., at the steps of the state capitol in Austin, Texas at all times). In another example, the item may have a consistent appearance (e.g., a sign reading “Live Music Capitol of the World” in orange letters), or the item may have a varying appearance (e.g., a sign reading “Silicon Hills” in scrolling light emitting diode lettering). The perception of being physically present in the virtual environment may be created by presenting three-dimensional and/or 360 degree images of the virtual environment and/or by controlling one or more systems in the user's vicinity to generate simulated environmental effects (e.g., raising or lowering the ambient temperature, dimming or brightening the ambient lighting, generating specific sounds, scents, or tactile sensations, and the like). These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

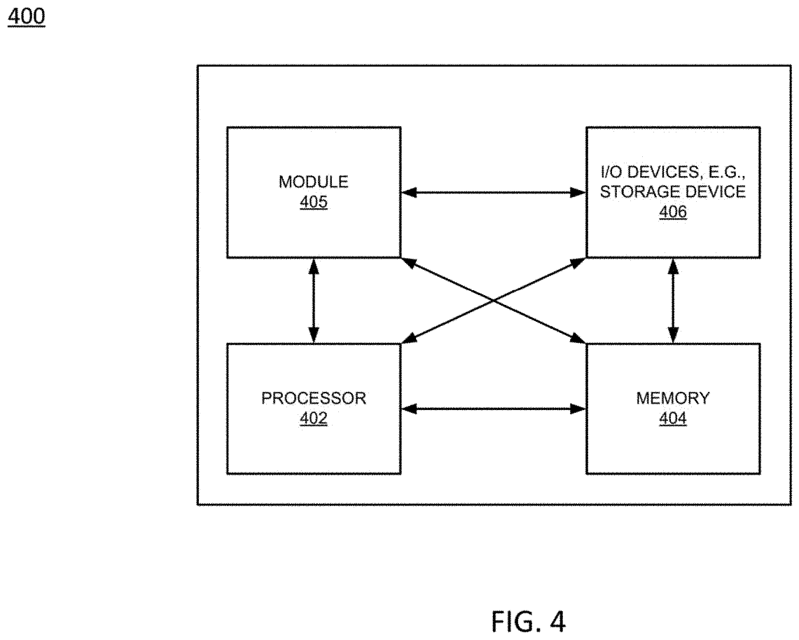

In accordance with the present disclosure, network 102 may include an application server (AS) 104, which may comprise a computing system or server, such as computing system 400 depicted in FIG. 4, and may be configured to provide one or more operations or functions in connection with examples of the present disclosure for aligning metaverse activities with multiple physical environments. The network 102 may also include a database (DB) 106 that is communicatively coupled to the AS 104. The database 106 may contain one or more instances of items (e.g., stored internally) or references to items (e.g., stored elsewhere but used in this system) in the metaverse.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure. Thus, although only a single application server (AS) 104 and a single database (DB) 106 are illustrated, it should be noted that any number of servers and databases may be deployed, and which may operate in a distributed and/or coordinated manner as a processing system to perform operations in connection with the present disclosure. Moreover, it should be further noted that while the present disclosure may at times make explicit reference to the metaverse, the DB 106 may also serve as a stand-alone database, a hybrid database-metaverse combination, or a proxy to metaverse representations and storage.

In one example, AS 104 may comprise a centralized network-based server for generating extended reality environments. For instance, the AS 104 may host an application that renders immersive XR environments which are accessible by users utilizing various user endpoint devices. In one example, the AS 104 may be configured to acquire information about multiple physical environments from which multiple users are joining an extended reality environment, and render an extended reality environment that provides a safe and consistent immersive experience for all users despite differences in the users' respective physical environments. For instance, the AS 104 may generate an immersive XR gaming environment in which the boundaries of the XR environment are configured to prevent users from moving in such a way that collisions with objects in the user's respective physical environments would be likely. Furthermore, the AS 104 may adapt the XR environment to “fit” to each user's respective physical environment. For instance, the locations of interactive objects within the XR environment may be moved when presented to a first user who is shorter than the other users so that the interactive objects are within the first user's reach. For a second user who is joining the XR environment from a relatively small physical environment, the appearance of the XR environment may be scaled or otherwise adjusted so that the second user's movements in the XR environment appear to cover more ground than the second user's movements cover in the small physical environment.

In one example, AS 104 may comprise a physical storage device (e.g., a database server) to store a pool of media content. The pool of media content may comprise both immersive and non-immersive items of media content, such as still images, video (e.g., two dimensional video, three-dimensional video, 360 degree video, volumetric video, etc.), audio, and the like. The pool of media content and the individual items of media content may also include references to the metaverse which specify dependencies on additional items (e.g., a nostalgic photo must be coupled with a nostalgic guitar from the metaverse) or items of media content in the pool of media content may be iconic, persistent items within the metaverse itself (e.g., a historical reference video of the United States Declaration of Independence).

In a further example, the AS 104 may store models of known physical environments (e.g., physical environments from which users have accessed XR environments in the past). For instance, if a user frequently joins a virtual yoga class from his or her living room, then the AS 104 may store a model of the user's living room so that the living room dimensions and obstacles do not have to be identified (as discussed in further detail below) each time the user joins the virtual yoga class from the user's living room. Instead, the user may select the user's living room from a menu of stored physical locations, and the AS 104 may automatically retrieve information about the obstacles and dimensions. In one example, the AS 104 may also store information about adjustments to be made to XR objects presented in a known physical environment (e.g., an extent to which virtual objects or distances may be scaled or the like). In another example, the AS 104 may automatically determine both the physical and virtual environments using network or operational data from the UE 112 or 114 as the living room and event data (e.g., a calendar appointment, recurring application launch record, etc.) from the UE 112 or 114 to determine the virtual yoga class environment.

In one example, the DB 106 may store the pool of media content and the models of the known physical environments, and the AS 104 may retrieve individual items of media content and individual models of known physical environments from the DB 106 when needed. For ease of illustration, various additional elements of network 102 are omitted from FIG. 1.

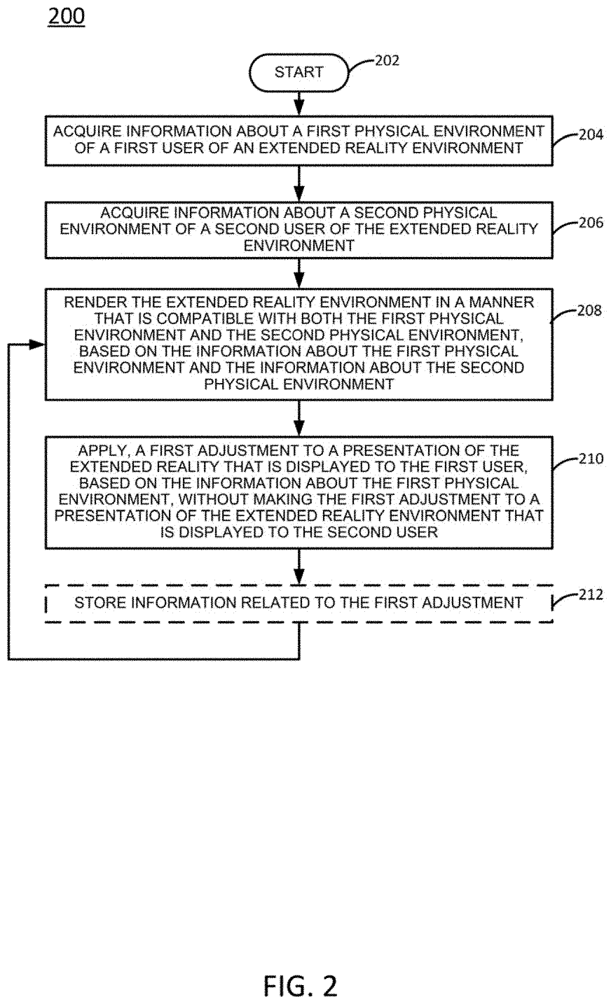

In one example, access network 122 may include an edge server 108, which may comprise a computing system or server, such as computing system 400 depicted in FIG. 4, and may be configured to provide one or more operations or functions for aligning metaverse activities with multiple physical environments, as described herein. For instance, an example method 200 for aligning metaverse activities with multiple physical environments is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components.

Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, e.g., a user endpoint device 112, and access network 120 may be in communication with one or more devices, e.g., a user endpoint device 114. Access networks 120 and 122 may transmit and receive communications between server 110, user endpoint devices 112 and 114, application server (AS) 104, other components of network 102, devices reachable via the Internet in general, and so forth. In one example, the user endpoint devices 112 and 114 may comprise mobile devices, cellular smart phones, wearable computing devices (e.g., smart glasses, virtual reality (VR) headsets or other types of head mounted displays, or the like), laptop computers, tablet computers, or the like (broadly “XR devices”). In one example, user endpoint devices 112 and 114 may comprise a computing system or device, such as computing system 400 depicted in FIG. 4, and may be configured to provide one or more operations or functions in connection with examples of the present disclosure for aligning metaverse activities with multiple physical environments.

In one example, server 110 may comprise a network-based server for generating XR environments. In this regard, server 110 may comprise the same or similar components as those of AS 104 and may provide the same or similar functions. Thus, any examples described herein with respect to AS 104 may similarly apply to server 110, and vice versa. In particular, server 110 may be a component of an XR system operated by an entity that is not a telecommunications network operator. For instance, a provider of an XR system may operate server 110 and may also operate edge server 108 in accordance with an arrangement with a telecommunication service provider offering edge computing resources to third-parties. However, in another example, a telecommunication network service provider may operate network 102 and access network 122, and may also provide an XR system via AS 104 and edge server 108. For instance, in such an example, the XR system may comprise an additional service that may be offered to subscribers, e.g., in addition to network access services, telephony services, traditional television services, and so forth.

In an illustrative example, an XR system may be provided via AS 104 and edge server 108. In one example, a user may engage an application on user endpoint device 112 (e.g., an “XR device”) to establish one or more sessions with the XR system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 may communicate with access network 122, network 102, the Internet in general, etc., via a WLAN that interfaces with access network 122.

In the example of FIG. 1, user endpoint device 112 in a first physical environment 116 may establish a session with edge server 108 for accessing or joining or generating an XR environment 124. In this case, the user endpoint device 112 may comprise a head mounted display worn by a first user 126, and the first physical environment 116 may comprise the first user's living room.

As discussed above, other user endpoint devices, such as user endpoint device 114, may also join the XR environment. The other user endpoint devices may be located in physical environments other than the first physical environment 116. For instance, the user endpoint device 114 may comprise another head mounted display worn by a second user 128 in a second physical environment 118, and the second physical environment 118 may comprise the second user's living room.

In one example, the AS 104 may receive information about the first physical environment 116 and the second physical environment 118 from sensors located in the first physical environment 116 and the second physical environment 118. The sensors may, for instance, be part of the user endpoint devices 112 and 114 or may comprise other sensors, such as IoT devices, that are not part of the user endpoint devices 112 and 114. The sensors may include, for example, image sensors (e.g., cameras), audio sensors (e.g., microphones), motion sensors, proximity sensors, temperature sensors, pressure sensors, and/or other types of sensors. The information may include information about the dimensions of the first physical environment 116 and the second physical environment 118, objects that are present in the first physical environment 116 and the second physical environment 118, and/or other information.

For instance, the AS 104 may determine, based on the information, that the first physical environment 116 comprises an x feet by y feet rectangular room, while the second physical environment 118 comprises a z feet by z feet square room (where z<y<x). Thus, the AS 104 may determine that the second physical environment 118 is smaller than the first physical environment 116. In addition, the AS 104 may determine, based on the information, that the second physical environment 118 includes potential obstructions such as a couch, a television, and/or a large houseplant. Thus, the second user 128 may not have as much room to move around as the first user 126.

When the AS 104 renders the XR environment 124, the XR environment 124 may be rendered so that the first user 126 and the second user 128 see the same objects in the XR environment 124. However, the presentation of the XR environment on the user endpoint devices 112 and 114 may vary depending upon the limitations of the physical environments 116 and 118 in which the user endpoint devices 112 and 114 are being used. For instance, the AS 104 may scale presentation of the XR environment 124 on the user endpoint device 114 due to the smaller dimensions of the second physical environment 118. Scaling the presentation may include, for instance, sizing virtual objects to make the virtual objects appear further away, adjusting the appearance of a path that the second user 128 is walking so that the second user 128 walks a curving trajectory (e.g., shown as a 90 degrees rotated orientation in FIG. 1) in the second physical environment 118 (e.g., to avoid colliding with the couch), but the path appears as a straight line on the display of the user endpoint device 112, and/or other adjustments. Scaling to a different extent (or no scaling at all) may be necessary for presentation of the XR environment 124 on the user endpoint device 112, which is located in the larger first physical environment 116.

Thus, the AS 104 may ensure that even though the first user 126 and the second user 128 are joining the XR environment 124 from physical locations having different dimensions and/or obstacles, that the first user 126 and the second user 128 are still able to experience the XR environment 124 in a relatively consistent manner, as well as in a manner that is safe for both users (e.g., does not cause either the first user 126 or the second user 128 to collide with any objects in the respective physical environments).

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of an example method 200 for aligning metaverse activities with multiple physical environments in accordance with the present disclosure. In one example, the method 200 may be performed by an XR server that is configured to generate XR environments, such as the AS 104 or server 110 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may acquire information about a first physical environment of a first user of an extended reality environment. In one example, the XR environment may comprise, for instance, a multiverse game, an AR coworking space, a virtual classroom, a virtual physical fitness class, a professional or educational training simulation, or the like. In one example, the XR environment may be capable of supporting the interaction of multiple different users who may be joining the XR environment from multiple different physical locations. Thus, the first physical environment may comprise the physical environment from which the first user is joining the XR environment (e.g., the first user's home or office, an arcade or other commercial establishments that offer access to XR experiences, or the like).

In one example, the information about the first physical environment may include the physical dimensions and boundaries of the first physical environment (e.g., the size and shape of the first physical environment) and the locations of any objects within those physical dimensions and boundaries (e.g., walls, architectural features such as columns or stairs, furniture, etc.).

In one example, the first user may provide the information about the first physical environment by selecting the first physical environment from a list or menu of a plurality of physical environments. In this case, each physical environment of the plurality of physical environments may comprise a physical environment for which the processing system has access to stored information. For instance, the first physical environment may comprise a physical environment from which the first user (or another user other than the first user) has joined an XR environment in the past. As an example, the first user may always join a virtual yoga class from their living room. Thus, the processing system may have stored (with the user's permission) information about the first user's living room during one of the past virtual yoga classes. In another example, information about frequently used physical locations may be pre-configured for use by the processing system. For instance, an arcade may include a dedicated space for XR gaming. In this case, the operator of the arcade may store information about the dedicated space so that the information does not need to be provided to the processing system every time a new XR game is launched in the dedicated space.

In another example, the first user may provide the information about the first physical environment by scanning the first physical environment with a camera and providing the images captured by the camera to the processing system. With the images provided by the first user, the processing system may be able to construct a twin space that represents the first physical environment. In this case, the user may provide further information about the first physical environment through other modalities. For instance, where the first physical environment comprises room in the user's home, the user may provide images of the walls of the room and then additionally provide the dimensions of the walls by speaking the dimensions or typing the dimensions (e.g., “this wall is ten feet long”).

In another example, the processing system may be able to obtain the information about the first physical environment by communicating directly with other devices or sensors (e.g., IoT devices) in the first physical environment, where permitted by the user. For instance, the processing system may be able to obtain images and dimensions of the first physical environment from the cameras of a home security system.

In step 206, the processing system may acquire information about a second physical environment of a second user of the extended reality environment. As discussed above, the XR environment may be capable of supporting the interaction of multiple different users who may be joining the XR environment from multiple different physical locations. In other words, the first user and the second user (and, potentially, additional users) may be seeking to experience the same portion of the XR environment simultaneously (e.g., as a “shared immersion”). Thus, the second physical environment may comprise the physical environment from which the second user is joining the XR environment (e.g., the second user's home or office, an arcade or other commercial establishments that offer access to XR experiences, or the like). In one example, the second user is a different user from the first user, and the second physical environment is a different physical environment from the first physical environment. For instance, the first user and the second user may be friends who are participating in the same virtual yoga class. The first user may be joining the virtual yoga class from the living room in the first user's home in New York, while the second user may be joining the virtual yoga class from the basement of the second user's home in Texas.

In one example, the information about the second physical environment may comprise any of the same information that was acquired for the first physical environment. For instance, the information about the second physical environment may include the physical dimensions and boundaries of the second physical environment (e.g., the size and shape of the second physical environment) and the locations of any objects within those physical dimensions and boundaries (e.g., walls, architectural features such as columns or stairs, furniture, etc.). The information about the second physical environment may also be provided in any of the same ways that the information about the first physical environment can be provided (e.g., selection from a predefined menu, second user scanning with a camera, from sensors located in the second physical environment, etc.).

In step 208, the processing system may render the extended reality environment in a manner that is compatible with both the first physical environment and the second physical environment, based on the information about the first physical environment and the information about the second physical environment. In one example, the extended reality environment is considered to be “compatible” with a physical environment if the extended reality environment is configured in such a way as to minimize collisions between objects in the physical environment and a user who is joining the extended reality environment from the physical environment. For instance, as discussed above, the appearance of the XR environment (e.g., the location of a virtual item) may be adjusted to prevent the first user and the second user from moving in directions within their respective physical environments that might cause the first user or the second user to collide with a wall, a piece of furniture, or another item that is present in their respective physical environment. Interactions of the first user and the second user with certain virtual items in the XR environment may also be limited to prevent movements that might result in physical injury to one of: the first user or the second user.

Thus, in one example, rendering the XR environment may include identifying areas of the XR environment that are “off limits” or into which the first user and the second user are not allowed to go, based on the limitations of the first physical environment and the second physical environment. For instance, a first “off limits” area may be identified based on the information about the first physical environment, while a second, different “off limits” area may be identified based on the information about the second physical environment. By identifying the off limits areas, the processing system may define the boundaries of a common space within the XR environment in which both the first user and the second user can safely move and interact.

In one example, rendering the XR environment may include differing the presentation of the XR environment to the first user and the second user. For instance, based on the relative sizes and dimensions of the first physical environment and the second physical environment, as well as the positions of the first user and the second user within the first physical environment and the second physical environment, the common space within the XR environment in which both the first user and the second user can safely move and interact may “fit” differently when aligned to first physical environment as opposed to the second physical environment. Thus, the processing system may orient the common space in a first way for the first user, but orient the common space in a second, different way for the second user. In this case, the processing system may compute a first mapping between the XR environment (or the common space) and the first physical environment and a second mapping between the XR environment (or the common space) and the second physical environment.

In another example, rendering the XR environment may include initiating a dialogue (e.g., a spoken or audible dialogue or a text-based dialogue) with at least one of the first user and the second user. The dialogue may solicit the first user's and/or the second user's assistance or action in mediating conflicts that inhibit the rendering of the XR environment. For instance, the processing system may ask the first user if it is possible to move an object that is present in the first physical environment (e.g., a coffee table), where moving the object may make it easier for the processing system to render an XR environment that is better suited for providing an optimal XR experience for the first user and the second user. For instance, by moving the coffee table in the first physical environment, this may make it easier to find a common space within the XR environment in which both the first user and the second user can safely move and interact.

In step 210, the processing system may apply a first adjustment to a presentation of the extended reality environment that is displayed to the first user, based on the information about the first physical environment, without making the first adjustment to a presentation of the extended reality environment that is displayed to the second user. The first adjustment may allow the first user to interact more fully with the XR environment, or to interact with the XR environment in a manner that is commensurate with the second user's ability to interact with the XR environment. As discussed above, in one example, the first adjustment is not made to a presentation of the XR environment that is displayed to the second user. Thus, although the first adjustment may be needed to allow the first user to interact more fully with the XR environment, the second user may be able to fully interact with the XR environment without the first adjustment (due to the differences between the first physical environment and the second physical environment).

For instance, the first adjustment may adjust the appearance of the XR environment based on the first user's physical dimensions, such as height or range of motion. As an example, the XR environment may include an interactive object that is placed high up (e.g., on a shelf or in a tree). If the first user is significantly shorter than the second user, then placing the interactive object at the same height (e.g., x feet above the ground) for both users may not provide the same experience or opportunities for both users (e.g., the second user may be able to reach and interact with the interactive object, but the first user may not). In this case, the first adjustment may adjust the position of the interactive object in the presentation of the XR environment that is displayed to the first user, so that the interactive object is within the first user's reach. Notably, the presentation of the XR environment that is displayed to the second user may remain unchanged or may not be adjusted, as no adjustment may be needed in order to allow the second user to reach and interact with the interactive object.

In another example, the first adjustment may alter the appearance of the XR environment to compensate for the dimensions of the first physical environment. Altering the appearance of the XR environment may involve resizing the presentation of the XR environment that is displayed to the first user. For instance, the XR environment may comprise a gaming environment in which the first user and the second user must walk along a path. However, the dimensions of the first physical environment may be significantly smaller than the dimensions of the second physical environment. In this case, the processing system may map the XR environment to the smaller first physical environment in a manner that allows the first user to appear to have the same experience as the second user in the XR environment. For instance, the first adjustment may make it appear that a small step in the first physical environment covers the same distance as a large step in the second physical environment. In this way, even if the second user is covering a greater distance in the second physical environment than the first user is covering in the first physical environment, it may still appear to the first user and the second user that they are covering the same distance in the XR environment.

In another example, the path may follow a straight line in the XR environment. However, there may not be enough room in the first physical environment for the first user to walk the full length of the straight line path. In this case, the first adjustment may comprise altering the appearance of the path (and/or items along the path) in the XR environment in a way that compels the first user to walk a curved (or otherwise not straight line) trajectory through the first physical environment (e.g., to walk laps around a perimeter of the first physical environment). However, in the XR environment, the path may appear to the second user as a straight line. To the second user, it may or may not appear as if the first user is walking a curved trajectory in the XR environment.

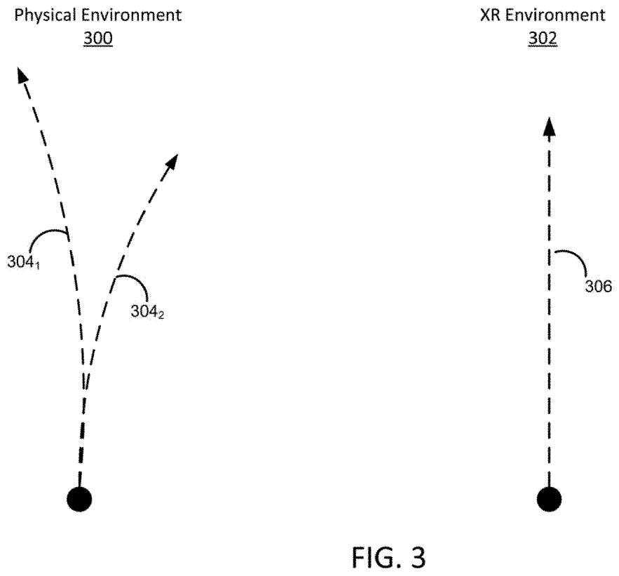

FIG. 3, for instance, illustrates an example physical environment 300 in which two curved paths (i.e., physical path 304₁ and physical path 304₂) that a user may walk in the physical environment 300 are depicted. In other words, to follow either of the physical path 304₁ and physical path 304₂ in the physical environment 300, the user would walk a curved trajectory (e.g., to walk around an obstacle or to cover a greater distance within a confined space). However, the presentation of either of the physical path 304₁ and physical path 304₂ in the XR environment 302 may be adjusted so that the user feels as if they are walking in a straight line or along a straight path 306. For instance, the scenery around the path may be manipulated to make it appear as if the user is walking in a straight line.

In another example, the first adjustment may comprise an adjustment that accounts for an action taken by the first user, the second user, or a third user (who is different from the first and second users). For instance, where the XR environment comprises objects with which users may interact, the presentation of the XR environment that is displayed to the first user may reflect interactions of other users with these objects. As an example, if the second user (or third user) opens a box in the XR environment, breaks a ladder in the XR environment, or opens a door in the XR environment, the presentation of the XR environment that is displayed to the first user will show the second user (or third user) opening the box, breaking the ladder, or opening the door.

In another example, the first adjustment may comprise temporarily adding a representation of a transient moving object that is present in the first physical environment into the presentation of the XR environment that is displayed to the first user. For instance, if the first user's pet or family member enters the first physical environment but is not engaged with the XR environment, a virtual representation of the pet or family member may be temporarily added to the presentation of the XR environment that is displayed to the first user, so that the first user may be aware of the pet's or family member's presence and position in the first physical environment (and therefor avoid collision with the pet or family member). The virtual representation of the pet or family member in the XR environment may not be interactive (e.g., the first user may not be able to interact with the virtual representation of the pet of family member in the XR environment). In one example, the virtual representation of the pet or family member may be removed from the presentation of the XR environment that is displayed to the first user when the pet or family member exits the first physical environment.

Thus, the first adjustment that is applied to the presentation of the XR environment that is displayed to the first user may be applied without applying the same first adjustment to the presentation of the XR environment that is displayed to the second user. The presentation of the XR environment that is displayed to the second user may not be adjusted at all, or may be adjusted in a manner that is different from the first adjustment (e.g., may comprise a second adjustment, where the second adjustment may be made in any of the manners described above with respect to the first adjustment).

Referring back to FIG. 2, in optional step 212 (illustrated in phantom), the processing system may store information related to the first adjustment. For instance, as discussed above, the processing system may have access to stored information about a plurality of physical environments. The stored information may include stored models that describe or illustrate the shapes, dimensions, boundaries, and/or obstacles for each physical environment of the plurality of physical environments. Thus, a user who is joining the XR environment from a physical environment for which a model is stored may not need to scan the physical environment with a camera (or other sensors) in order to provide the information needed by the processor to generate the XR environment.

In one example, where a model for the first physical environment existed prior to execution of the method 200, the processing system may simply update the existing model for the first physical environment with the information related to the first adjustment. For instance, if the first physical environment is the first user's living room, the shape and dimensions of the living room may not have changed since the last time the existing model was used (or since the last time the first user joined an XR environment from their living room). However, the first user may have purchased new furniture for the living room (e.g., a new coffee table where there was no coffee table before) or moved existing furniture to new locations in the living room (e.g., moved a couch from one wall to a different wall), which may necessitate making new adjustments to XR environments to account for new obstacles and/or obstacle locations.

In another example, where no model for the first physical environment existed prior to execution of the method 200, the processing system may create and store a new model for the first physical environment, which may expedite the rendering of XR environments when the first user joins from the first physical environment in the future.

In one example, the stored information may not only include information about the shape, dimensions, and obstacles of a physical environment, but may also make note of which types of adjustments did or did not work in the physical environment for particular users. For instance, the first adjustment may have adjusted a path walked by the first user so that the first user walked a curved trajectory in the first physical environment, but the path in the XR environment appeared as a straight line. The information stored by the processing system may note whether the first user successfully walked the path without colliding with any obstacles, or whether the first user collided with an obstacle, lost their balance, or the like. This information may help the processing system to make more effective adjustments to the presentations of XR environments in the future.

In one example, the stored information and updates indicating the success or failure of instances of the strategies discussed in connection with the method 200 may be attributed to certain types of spaces (e.g., rooms), types or properties of objects in the spaces, and/or attributes in the experience in machine learned models that are not specific to a single virtual or physical space. As described above, attributes of a space (e.g., the geometry or density or sparsity of objects within a space), certain types of objects in the physical environment (e.g., immovable houseplants, moveable furniture, pets or other people who are not present in the XR environment, etc.), or certain attributes of the immersive experience may be encapsulated by a machine learning model to predict which strategy is least disruptive to the XR environment for all or most users.

In one example, these machine learning models may be executed or distributed by the application server 104 of FIG. 1 or one or more of the user endpoint devices 112 and 114 to minimize the computational requirements of the same environment in the future. In another example, these machine learning models may be owned by an XR environment or platform (e.g., facilitating a dancing game platform or an astronaut simulator platform). In yet another example, the utilization of the machine learning models may be enforced upon future users of a particular platform to minimize variance for real-world conditions. For instance, in an astronaut simulator adaptation model, users may train in their own physical environments (e.g., homes) for a walk on the moon, but the amount of virtual adaptation may be strictly defined and limited by the adaptation model. Thus, when the users are present in the same shared physical environment, the physical interactions of the users (e.g., the strength required to move, speed, interactions with objects, etc.) may be finely tuned to match real environmental conditions instead of conditions that may have otherwise been learned during interaction with the simulator.

The method may return to step 208 and may continue to render the extended reality environment as described above (including applying adjustments as needed to one or both of the presentations of the XR environment that is displayed to the first user and the presentation of the XR environment that is displayed to the second user) until a signal is received that indicates that the first user and/or the second user wishes to exit the XR environment. For instance, the first user and/or the second user may power down their respective user endpoint device, may speak a command or press a button to exit the XR environment, or the like.

Although the method 200 describes rendering (and adjusting the presentation of) an XR environment that is compatible with two different physical environments, it will be appreciated that the same operations could be performed to render an XR environment that is compatible with any number of physical environments. In other words, any number of users may join the XR environment from any number of different respective physical environments, and the method 200 may attempt to render an XR environment that is a “best fit” to all of the different physical environments.

As discussed above, examples of the present disclosure could be used to ensure that two or more players in a single (i.e., the same) multiverse game have consistent experiences. For instance, a first player may be joining the single multiverse game from a first physical environment, while a second player may be joining the single multiverse game from a second physical environment that is smaller than the first physical environment. Examples of the present disclosure would ensure that a single virtual environment is created in which environmental constraints are similar for both players, despite the differences in the players' physical environments.

However, examples of the present disclosure could also be applied to XR experiences other than gaming. For instance, two (or more) office workers who are working from home may join an AR coworking space that makes it appear as if the office workers are working together in the same space. The AR coworking space may provide an AR space in which the office workers can collaborate. As an example, the AR space may include a virtual whiteboard. The virtual whiteboard will need to be positioned in a location in the AR space that is accessible to all of the office workers. Thus, examples of the present disclosure may adjust for the different physical (home) environments of the office workers by identifying a “lowest common denominator.” In this case, a mapping or warping function may be derived that maps the AR space to the different physical environments and allows for the identification of a common space that is accessible to all of the office workers. A similar approach could be used to place a virtual chalkboard in a virtual classroom, so that all students who are joining the virtual classroom from different physical environments (e.g., homes) may be able to access the chalkboard.

In another example, multiple users may join an AR physical fitness class, such as a virtual yoga class, from different physical environments (e.g., their respective homes). In this case, the physics of the different physical environments may need to be portrayed realistically in AR to ensure the safety of the users. As an example, the AR environment may be configured to ensure that all users are at least an arm's distance apart from each other in the AR environment to allow for both personal space and adequate room to perform certain yoga poses.

Furthermore, examples of the present disclosure can be extended to other applications beyond providing safe and consistent XR experiences for multiple, non-co-located users. For instance, examples of the present disclosure may be used to locate objects in a shared XR environment. As an example, a virtual whiteboard in a virtual classroom may be positioned such that a teacher and a student who are joining the virtual classroom from different physical environments see that virtual whiteboard in the same place in the virtual classroom. The virtual whiteboard may be anchored in the XR environment, but may correlate to different physical locations in the different physical environments.

In another example, a transform such as the transform that is used to make a user who is walking a curved path in a physical environment feel as if they are walking a straight line in the XR environment may be used to make further transformations to the XR environment. For instance, a physical environment may include a curved room with curved windows. The XR environment may apply a highly deforming transform that makes the user feel as if they are standing in a long, straight hallway with doors on either side. In this case, the XR environment may position doors at the extremes of the curved room's walls.

In further examples, auxiliary devices, such as additional user endpoint devices, IoT devices, appliances, and/or the like may be utilized to further enhance adjustments to the presentation of the XR environment. For instance, as discussed above, a transform may be applied to make a user who is located in a small physical environment feel as if they are walking a straight line, when they are actually walking along a curving trajectory. However, even with the aid of this transform, the adjustment may not be sufficient to make the user feel that they are walking a straight line over a long distance. In this case, if a treadmill or similar device is present in the physical environment, examples of the disclosure may compel the user to walk on the treadmill to emulate the sensation of walking a greater distance.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 may be implemented as the system 400. For instance, a server (such as might be used to perform the method 200) could be implemented as illustrated in FIG. 4.

As depicted in FIG. 4, the system 400 comprises a hardware processor element 402, a memory 404, a module 405 for aligning metaverse activities with multiple physical environments, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for aligning metaverse activities with multiple physical environments may include circuitry and/or logic for performing special purpose functions relating to the operation of a home gateway or XR server. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for aligning metaverse activities with multiple physical environments (e.g., a software program comprising computer-executable instructions) can be loaded into memory 404 and executed by hardware processor element 402 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for aligning metaverse activities with multiple physical environments (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
acquiring, by a processing system including at least one processor, information about a first physical environment of a first user of an extended reality environment;
acquiring, by the processing system, information about a second physical environment of a second user of the extended reality environment;
rendering, by the processing system, the extended reality environment in a manner that is compatible with both the first physical environment and the second physical environment, based on the information about the first physical environment and the information about the second physical environment; and
applying, by the processing system, a first adjustment to a presentation of the extended reality environment that is displayed to the first user, based on the information about the first physical environment, without making the first adjustment to a presentation of the extended reality environment that is displayed to the second user.

2. The method of claim 1, wherein the first physical environment is different from the second physical environment.

3. The method of claim 1, wherein the information about the first physical environment comprises at least one of: physical dimensions of the first physical environment, boundaries of the first physical environment, or locations of objects within the physical dimensions of the first physical environment, and wherein the information about the second physical environment comprises at least one of: physical dimensions of the second physical environment, boundaries of the second physical environment, or locations of objects within the physical dimensions of the second physical environment.

4. The method of claim 1, wherein the information about the first physical environment is provided to the processing system via a selection by the first user of a first stored model from among a plurality of stored models, wherein each stored model of the plurality of stored models describes a different physical environment of a plurality of physical environments including the first physical environment.

5. The method of claim 4, wherein each different physical environment of the plurality of stored physical environments comprises a physical environment from which a user has previously joined an extended reality environment.

6. The method of claim 4, further comprising:
storing, by the processing system, information related to the first adjustment in connection with the first stored model.

7. The method of claim 1, wherein the information about the first physical environment is provided to the processing system via a scanning of the first physical environment with a camera and providing images captured by the camera to the processing system.

8. The method of claim 1, wherein the information about the first physical environment is retrieved from a stored model of the first physical environment.

9. The method of claim 1, wherein the extended reality environment is considered to be compatible with the first physical environment and the second physical environment when the extended reality environment is configured in such a way as to minimize collisions between the first user and at least one object in the first physical environment and collisions between the second user and at least one object in the second physical environment.

10. The method of claim 9, wherein the rendering comprises identifying, based on the information about the first physical environment and the information about the second physical environment, areas of the extended reality environment into which the first user and the second user are not permitted to go.

11. The method of claim 10, wherein the areas of the extended reality environment into which the first user and the second user are not permitted to go define boundaries of a common extended reality space within the extended reality environment.

12. The method of claim 11, wherein the rendering comprises computing a first mapping between the common extended reality space and the first physical environment and a second mapping between the common extended reality space and the second physical environment.

13. The method of claim 9, wherein the rendering comprises limiting interactions of the first user with a virtual item in the extended reality environment which might result in potential physical injury to the first user.

14. The method of claim 9, wherein the rendering comprises initiating a dialogue with the first user to solicit assistance from the first user in mediating a conflict that inhibits the rendering.

15. The method of claim 14, wherein the conflict comprises a position of the at least one object within the first physical environment.

16. The method of claim 1, wherein the first adjustment comprises adjusting a position of an interactive object in the presentation of the extended reality environment that is displayed to the first user, so that the interactive object is within a reach of the first user.

17. The method of claim 1, wherein the first adjustment comprises adjusting an appearance of a path in the presentation of the extended reality environment that is displayed to the first user, so that the first user perceives walking on a straight line path in the extended reality environment while walking a non-straight path in the first physical environment.

18. The method of claim 1, wherein the first adjustment comprises a temporary addition of a virtual representation of a transient moving object that is present in the first physical environment into the presentation of the extended reality environment that is displayed to the first user.

19. A non-transitory computer-readable medium storing instructions which, when executed by a processing system including at least one processor, cause the processing system to perform operations, the operations comprising:
acquiring information about a first physical environment of a first user of an extended reality environment;
acquiring information about a second physical environment of a second user of the extended reality environment;
rendering the extended reality environment in a manner that is compatible with both the first physical environment and the second physical environment, based on the information about the first physical environment and the information about the second physical environment; and
applying a first adjustment to a presentation of the XR environment that is displayed to the first user, based on the information about the first physical environment, without making the first adjustment to a presentation of the XR environment that is displayed to the second user.

20. A device comprising:
a processing system including at least one processor; and
a computer-readable medium storing instructions which, when executed by the processing system, cause the processing system to perform operations, the operations comprising:
acquiring information about a first physical environment of a first user of an extended reality environment;
acquiring information about a second physical environment of a second user of the extended reality environment;
rendering the extended reality environment in a manner that is compatible with both the first physical environment and the second physical environment, based on the information about the first physical environment and the information about the second physical environment; and
applying a first adjustment to a presentation of the XR environment that is displayed to the first user, based on the information about the first physical environment, without making the first adjustment to a presentation of the XR environment that is displayed to the second user.
